(19) United States
(12) Patent Application Publication
(10) Pub. No.: US 2018/0293755 A1
(43) Pub. Date: Oct. 11, 2018

(54) USING DYNAMIC FACIAL LANDMARKS FOR HEAD GAZE ESTIMATION

(71) Applicant: International Business Machines Corporation, Armonk, NY (US)

(72) Inventors: Karan Ahuja, New Delhi (IN); Kuntal Dey, New Delhi (IN); Seema Nagar, Bangalore (IN); Roman Vaculin, Bronxville, NY (US)

(21) Appl. No.: 15/841,653

(22) Filed: Dec. 14, 2017

Related U.S. Application Data
(63) Continuation of application No. 15/479,744, filed on Apr. 5, 2017.

(51) Int. Cl. G06T 7/73; G06K 9/00

(52) U.S. Cl. CPC G06T 7/74; G06T 2207/10016; G06T 2207/30201; G06K 9/0061; G06K 9/00281; G06T 7/75

(57) ABSTRACT

Techniques are provided for automatically dynamically determining one or more additional landmarks to produce a set of landmarks that includes at least four non-planar landmarks, in response to receiving a captured image that excludes a portion of a head or face that included one or more landmarks previously employed for gaze estimation/tracking from a previously captured image of the head or face.

### BACKGROUND

The subject invention relates generally to creating a three-dimensional (3D) head model and determining dynamic facial landmarks for head pose and gaze estimation.

### SUMMARY

The following presents a summary to provide a basic understanding of one or more embodiments of the invention. This summary is not intended to identify key or critical elements, or delineate any scope of the particular embodiments or any scope of the claims. Its sole purpose is to present concepts in a simplified form as a prelude to the more detailed description that is presented later. One or more embodiments of the present invention include a system, computer-implemented method, and/or computer program product, in accordance with the present invention.

One embodiment of the invention is a system, that comprises a memory that stores computer executable components; and a processor that executes the computer executable components stored in the memory. The computer executable components of the system can comprise: a gaze determination component that: determines a second set of landmarks of a head from a second image of the head of a stream of images of the head, wherein the second set of landmarks comprises a defined quantity of landmarks, wherein the defined quantity is at least four non-planar landmarks, wherein the second set of landmarks comprises at least one landmark that was not in a first set of landmarks of the head used for gaze estimation associated with a first image of the head that is prior to the second image in the stream of images; and determines a gaze vector for the head based on the second set of landmarks.

Other embodiments include a computer-implemented method and a computer program product.

### BRIEF DESCRIPTION OF THE DRAWINGS

FIG. 1 illustrates an example, non-limiting system in accordance with one or more embodiments described of the present invention.

FIG. 2 illustrates a more detailed, non-limiting, example system component in accordance with one or more embodiments of the present invention.

FIG. 3 illustrates another, non-limiting, example of a system component in accordance with one or more embodiments of the present invention.

FIG. 4 illustrates an exemplary, non-limiting, image of a stream of images in accordance with one or more embodiments of the present invention.

FIG. 5A illustrates an exemplary, non-limiting, image with landmarks identified in accordance with one or more embodiments of the present invention.

FIG. 5B illustrates another exemplary, non-limiting, image with landmarks identified in accordance with one or more embodiments of the present invention.

FIG. 5C illustrates yet another exemplary, non-limiting, image with landmarks identified in accordance with one or more embodiments of the present invention.

FIG. 6 illustrates an example, non-limiting computer-implemented method in accordance with one or more embodiments of the present invention.

FIG. 7 illustrates another exemplary, non-limiting computer-implemented method in accordance with one or more embodiments of the present invention.

FIG. 8 illustrates an example, non-limiting operating environment in accordance with one or more embodiments of the present invention.

### DETAILED DESCRIPTION

The following detailed description is merely illustrative and is not intended to limit embodiments and/or application or uses of embodiments. Furthermore, there is no intention to be bound by any expressed or implied information presented in the preceding Background or Summary sections, or in the Detailed Description section.

One or more embodiments are now described with reference to the drawings, wherein like referenced numerals are used to refer to like elements throughout. In the following description, for purposes of explanation, numerous specific details are set forth in order to provide a more thorough understanding of the one or more embodiments. It is evident; however in various cases, that the one or more embodiments can be practiced without these specific details.

Eye gaze estimation refers to detecting a point in a given space at which an observer (e.g., such as a human or animal) is looking. For example, a camera can capture an image of a head, and using 3D landmarks (e.g facial or head landmarks) a determination of a pose of an eye and/or head, a system can estimate a gaze vector associated with the eye and/or head. Eye gaze tracking refers to detecting respective points in a given space at which the observer is looking over time. As images are captured by the camera, the head can move such that portions of the head will change in size due to the head moving closer to and/or further away from the camera, and such that portions of the head are no longer in a captured image due to the head moving, such as in a non-limiting example, the head moving up, down, left, right, closer to the camera, and/or further away from the camera.

It can be a challenge to perform gaze estimation using non-stereoscopic image information obtained provided by monocular cameras, such as those found in many common systems, such as in a non-limiting example, a mobile phone camera, a laptop camera, a tablet camera, a security camera, or any other suitable monocular camera.

It can also be a challenge to perform gaze estimation when relying on a defined set of landmarks (e.g., facial landmarks or head landmarks), because some of the defined landmarks can be excluded when portions of the head are not included in a captured image. In a non-limiting example, if a defined set of landmarks includes six landmarks, two corners of the right eye, two corners of the left eye, and the two corners of the mouth, and a conventional eye gaze estimation/tracking system cannot see the mouth, the head pose estimation of the conventional eye gaze estimation/tracking system will fail, which will result in gaze estimation also failing for a captured image and gaze tracking failing for a set of captured images where some of defined landmarks are not visible in the one or more captured images. This can occur, for example, when an individual brings a mobile phone camera too close to their face (such as for reading), turns their head away from the mobile phone camera, or moves their face away from the mobile phone camera, such that only a portion (e.g., one half or three-fourths) of their face is visible to the mobile phone camera.

Furthermore, employing a generic 3D head and/or face model for determining eye and/or head pose, can lead to inaccurate estimation based on the variety of head shapes and sizes.

To address the challenges in gaze estimation and gaze tracking of the present invention, one or more exemplary embodiments of the invention can dynamically generate a 3D head and/or face model that is specific to a particular head for use in determining eye and/or head pose. For example, when a head enters a visual field of a monocular camera, the system can employ a plurality of image captures of the head to generate a 3D head and/or face model that is specific to the head.

Additionally, one or more exemplary embodiments of the invention can dynamically determine one or more additional landmarks to produce a set of landmarks that includes at least four non-planar landmarks, in response to receiving a captured image that excludes a portion of a head or face that included one or more landmarks previously employed for gaze estimation/tracking from a previously captured image of the head or face. For example, a first captured image can include the entire face and the system determines a set of landmarks including six landmarks, two corners of the right eye, two corners of the left eye, and the two corners of the mouth, that the system employs for head pose estimation and gaze estimation. In response to the system obtaining a second captured image of the face that does not include mouth, the system can determine one or more additional landmarks, such as the tip of the nose, along with the two corners of the right eye and two corners of the left eye, and employ the five landmarks for head pose estimation and gaze estimation. In response to the system obtaining a third captured image of the face that does include the eyes, the system can determine one or more additional landmark, such as the tip of the chin, along with the tip of the nose and the two corners of the mouth, and employ the four landmarks for head pose estimation and gaze estimation.

One or more embodiments of the subject invention is directed to computer processing systems, computer-implemented methods, apparatus and/or computer program products that facilitate efficiently, effectively, and automatically (e.g., without direct human involvement) perform gaze estimation/tracking (e.g. in real-time from a live stream of images) by generating a 3D head and/or face model that is specific to a particular head, and dynamically determining one or more additional landmarks to produce a set of landmarks that includes at least four non-planar landmarks, in response to receiving a captured image that excludes a portion of a head or face that included one or more landmarks previously employed for gaze estimation/tracking from a previously captured image of the head or face. The computer processing systems, computer-implemented methods, apparatus and/or computer program products can employ hardware and/or software to solve problems that are highly technical in nature (e.g., adapted to perform automated generation of a 3D head and/or face model that is specific to a particular head, adapted to dynamically determining one or more additional landmarks to produce a set of landmarks that includes at least four non-planar landmarks, in response to receiving a captured image that excludes a portion of a head or face that included one or more landmarks previously employed for gaze estimation/tracking from a previously captured image of the head or face) that are not abstract and that cannot be performed as a set of mental acts by a human. For example, a human, or even thousands of humans, cannot efficiently, accurately and effectively manually gather and analyze thousands of data elements related to performing gaze estimation/tracking in real-time from a live stream (e.g., series, sequence) of captured images in a real-time network based computing environment. One or more embodiments of the subject computer processing systems, methods, apparatuses and/or computer program products can enable the automated real-time, gaze estimation/tracking from a live stream of captured images by generating a 3D head and/or face model that is specific to a particular head, and dynamically determining one or more additional landmarks to produce a set of landmarks that includes at least four non-planar landmarks, in response to receiving a captured image that excludes a portion of a head or face that included one or more landmarks previously employed for gaze estimation/tracking from a previously captured image of the head or face, in a highly accurate and efficient manner By employing automated real-time, gaze estimation/tracking from a live stream of captured images by generating a 3D head and/or face model that is specific to a particular head, and dynamically determining one or more additional landmarks to produce a set of landmarks that includes at least four non-planar landmarks, in response to receiving a captured image that excludes a portion of a head or face that included one or more landmarks previously employed for gaze estimation/tracking from a previously captured image of the head or face, the processing time and/or accuracy associated with the existing automated query systems is substantially improved. Additionally, the nature of the problem solved is inherently related to technological advancements in real-time gaze estimation/tracking from a live stream of captured images that have not been previously addressed in this manner Further, one or more embodiments of the subject techniques can facilitate improved performance of automated real-time, gaze estimation/tracking from a live stream of captured images by generating a 3D head and/or face model that is specific to a particular head, and dynamically determining one or more additional landmarks to produce a set of landmarks that includes at least four non-planar landmarks, in response to receiving a captured image that excludes a portion of a head or face that included one or more landmarks previously employed for gaze estimation/tracking from a previously captured image of the head or face, that provides for more efficient usage of storage resources, processing resources, and network bandwidth resources to provide highly granular and accurate real-time gaze estimation/tracking from a live stream of captured images. For example, by providing accurate real-time gaze estimation/tracking from a live stream of captured images, wasted usage of processing, storage, and network bandwidth resources can be avoided by mitigating the need for to obtain stereoscopic image information.

By way of overview, aspects of systems apparatuses, products and/or processes in accordance with the present invention can be implemented as machine-executable component(s) embodied within machine(s), e.g., embodied in one or more computer readable mediums (or media) associated with one or more machines. Such component(s), when executed by the one or more machines, e.g., computer(s), computing device(s), virtual machine(s), etc. can cause the machine(s) to perform the operations described.

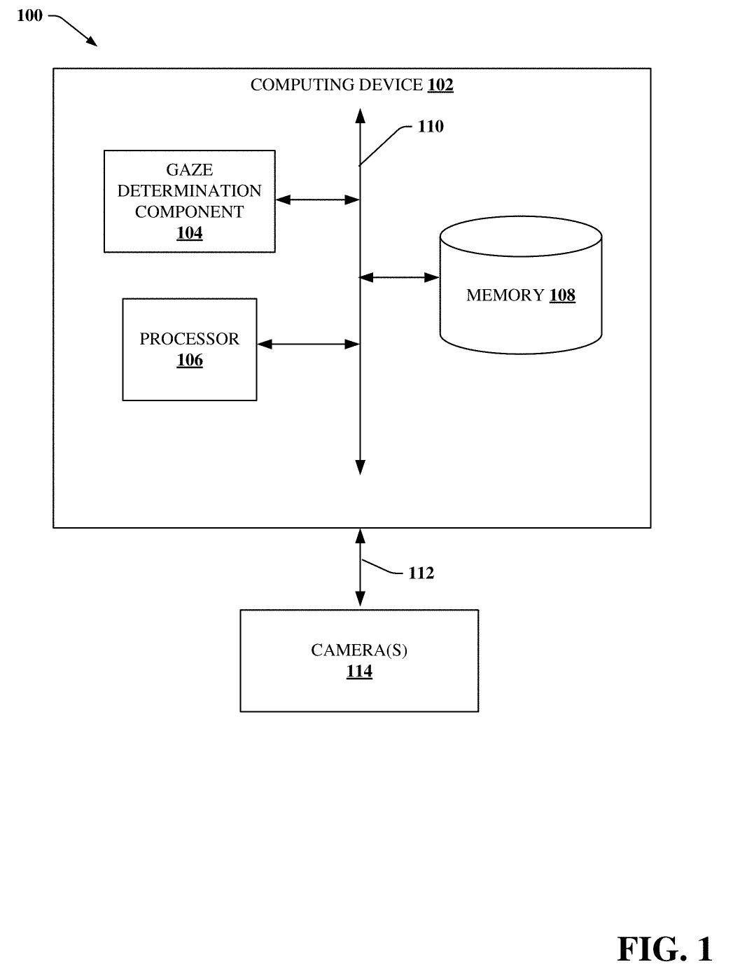

FIG. 1 illustrates an example, non-limiting system in accordance with one or more embodiments described of the present invention. System 100 can facilitates generating a 3D head and/or face model that is specific to a particular head, and dynamically determining one or more additional landmarks to produce a set of landmarks that includes at least four non-planar landmarks, in response to receiving a captured image that excludes a portion of a head or face that included one or more landmarks previously employed for gaze estimation/tracking from a previously captured image of the head or face in accordance with one or more embodiments of the present invention. Repetitive description of like elements employed in one or more embodiments of the present invention is omitted for sake of brevity.

As shown in FIG. 1, system 100 can include a computing device 102, one or more networks 112 and one or more cameras 114. Computing device 102 can include a gaze determination component 104 that can facilitate determining a gaze vector using dynamically generated landmarks. For example, gaze determination component 104 can generate a 3D head and/or face model that is specific to a particular head. Furthermore, gaze determination component 104 can dynamically determine one or more additional landmarks to produce a set of landmarks that includes at least four non-planar landmarks, in response to receiving a captured image that excludes a portion of a head or face that included one or more landmarks previously employed for gaze estimation/tracking from a previously captured image of the head or face.

Computing device 102 can also include or otherwise be associated with at least one included memory 108 that can store computer executable components (e.g., computer executable components can include, but are not limited to, the gaze determination component 104 and associated components), and can store any data generated by gaze determination component 104 and associated components. Computing device 102 can also include or otherwise be associated with at least one processor 106 that executes the computer executable components stored in memory 108. Computing device 102 can further include a system bus 110 that can couple the various computing device 102 components including, but not limited to, the gaze determination component 104, memory 108 and/or processor 106.

Computing device 102 can be any computing device that can be communicatively coupled to and/or include one or more cameras 114, non-limiting examples of which can include, but are not limited to, a wearable device or a non-wearable device. Wearable device can include, for example, heads-up display glasses, a monocle, eyeglasses, contact lens, sunglasses, a headset, a visor, a cap, a mask, a headband, clothing, or any other suitable device that can be worn by a human or non-human user. Non-wearable devices can include, for example, a mobile device, a mobile phone, a camera, a camcorder, a video camera, laptop computer, tablet device, desktop computer, server system, cable set top box, satellite set top box, cable modem, television set, monitor, media extender device, blu-ray device, DVD (digital versatile disc or digital video disc) device, compact disc device, video game system, portable video game console, audio/video receiver, radio device, portable music player, navigation system, car stereo, a mainframe computer, a robotic device, a wearable computer, an artificial intelligence system, a network storage device, a communication device, a web server device, a network switching device, a network routing device, a gateway device, a network hub device, a network bridge device, a control system, or any other suitable computing device 102. While a computing device 102 is shown in FIG. 1, in other embodiments, different types of devices can be associated with or include the components shown in FIG. 1 as part of the gaze determination component 104. For example, a device such as camera 114 can include all or some of the components of gaze determination component 104. All such embodiments are envisaged. Furthermore, while camera 114 is shown as separate from computing device 102, camera 114 can be part of computing device 102 and connected via system bus 110.

Camera(s) 114 can be any of one or more cameras that can capture one or more(e.g., a stream of) images A few (non-limiting) examples of which can include a monocular camera, a stereo camera, a video camera, or any other suitable type of camera. It is to be appreciated that computing device 102 and/or camera 114 can be equipped with communication components (not shown) that enable communication between computing device 102 and/or camera 114 over one or more networks 112. Although various embodiments of the present invention employ any suitable camera(s), some embodiments can benefit from non-stereoscopic information, such as may be provided by monocular camera. For avoidance of doubt, examples herein depicting camera 114 as a monocular camera should be considered non-limiting. Furthermore, while one or more examples of the present invention refer to a live stream of images, embodiments of the present invention can be employ one or more still images and/or a stored stream of images.

Various devices (e.g., computing device 102, cameras 114) and components (e.g., gaze determination component 104, memory 108, processor 106 and/or other components) of system 100 can be connected either directly or via one or more networks 112. Such networks 112 can include wired and wireless networks, including, but not limited to, a cellular network, a wide area network (WAN) (e.g., the Internet), or a local area network (LAN), non-limiting examples of which include cellular, WAN, wireless fidelity (Wi-Fi), Wi-Max, WLAN, radio communication, microwave communication, satellite communication, optical communication, sonic communication, or any other suitable communication technology.

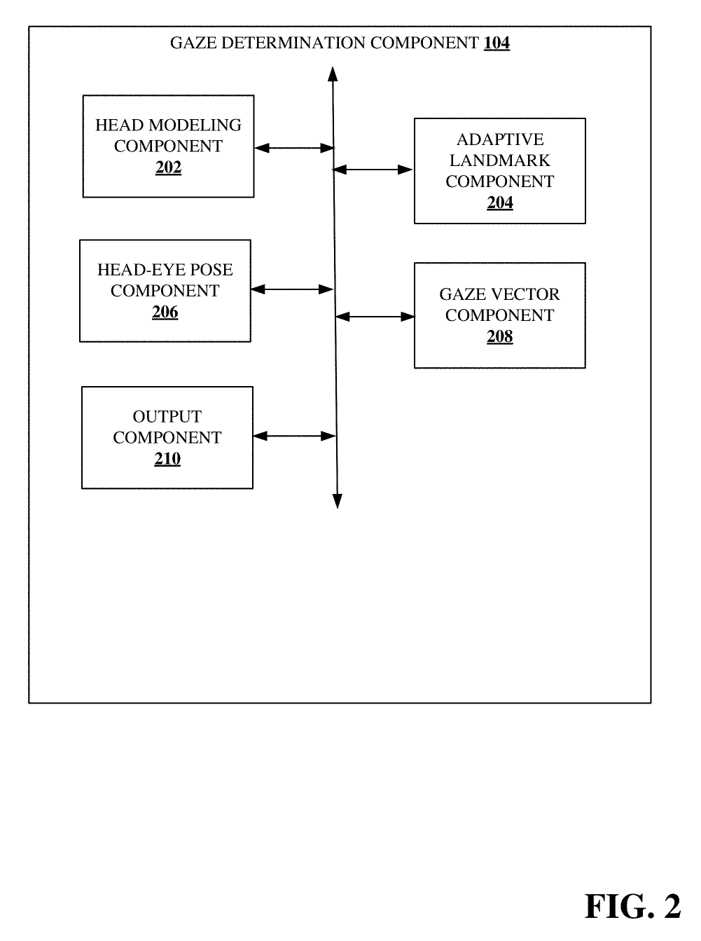

FIG. 2 illustrates a illustrates a more detailed, non-limiting, example system component in accordance with one or more embodiments of the present invention. Repetitive description of like elements employed in one or more embodiments of the present invention is omitted for sake of brevity. As depicted, gaze determination component 104 can include a head modeling component 202, adaptive landmark component 204, head-eye pose component 206, gaze vector component 208, and output component 210.

In one or more embodiments, the gaze determination component 104 can automatically generate a 3D head (e.g., head and/or face) model that is specific to a particular head based on one or more captured images from a stream of captured images from a camera 114 (e.g., monocular camera), and dynamically determine one or more additional landmarks to produce a set of landmarks that includes at least four non-planar landmarks, in response to receiving a captured image that excludes a portion of a head or face that included one or more landmarks previously employed for gaze estimation/tracking from a previously captured image of the head or face.

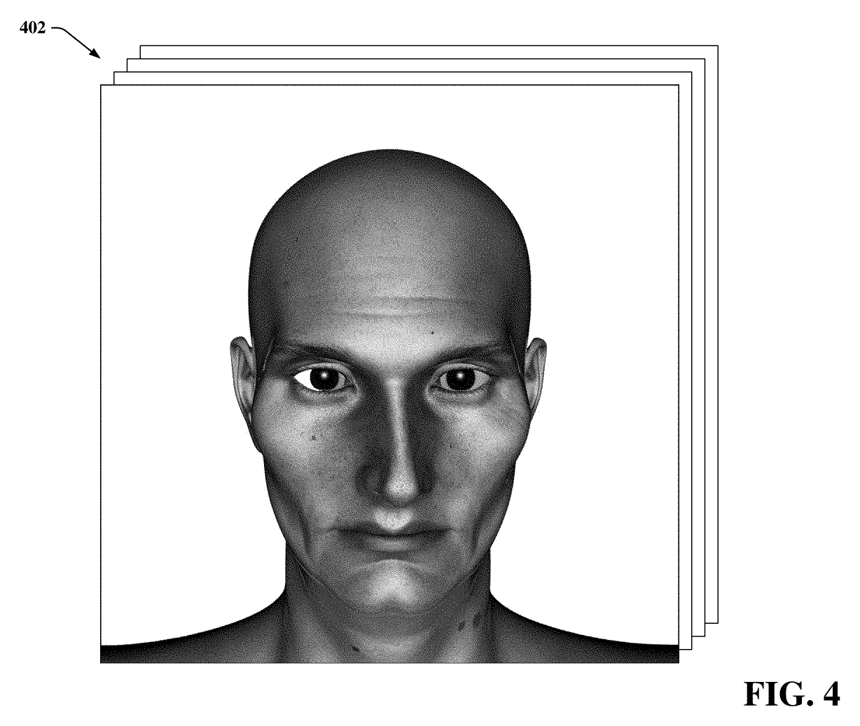

FIG. 4 illustrates an exemplary, non-limiting, image of a stream of images 402 in accordance with one or more embodiments of the present invention. It is to be appreciated that stream of images 402 can include any suitable number of pictures captured from a camera 114.

Referring back to FIG. 2, head modeling component 202 can automatically generate a 3D head model that is specific to a particular head based on one or more captured images from stream of captured images 402 as depicted in FIG. 4, that respectively include all or a portion of the head. Head modeling component 202 can use any suitable 3D head modeling algorithm that can generate a 3D head model from one or more captured images. Non-limiting examples of 3D head modeling algorithms can include, a deep learning algorithm, a Convolutional Neural Network (CNN) algorithm, Long short-term memory (LSTM) algorithm, Gated Recurrent Unit (GRU) algorithm, Attention Mechanism Deep Learning algorithm, Recurrent Neural Network (RNN) algorithm, a neural network algorithms, support vector machines (SVM), morphable model, an OpenFace Library model, or any other suitable 3D head modeling algorithm. In a non-limiting example, head modeling component 202 can obtain one or more captured images from the stream of captured images 402 from camera 114 and identify landmarks from the head and/or face in the captured images that are common to at least two captured images and employ a 3D head modeling algorithm to generate a 3D head model based on the identified landmarks. It is to be appreciated that landmarks employed for generating a 3D head model can be different than landmarks employed for head pose estimation and/or gaze estimation.

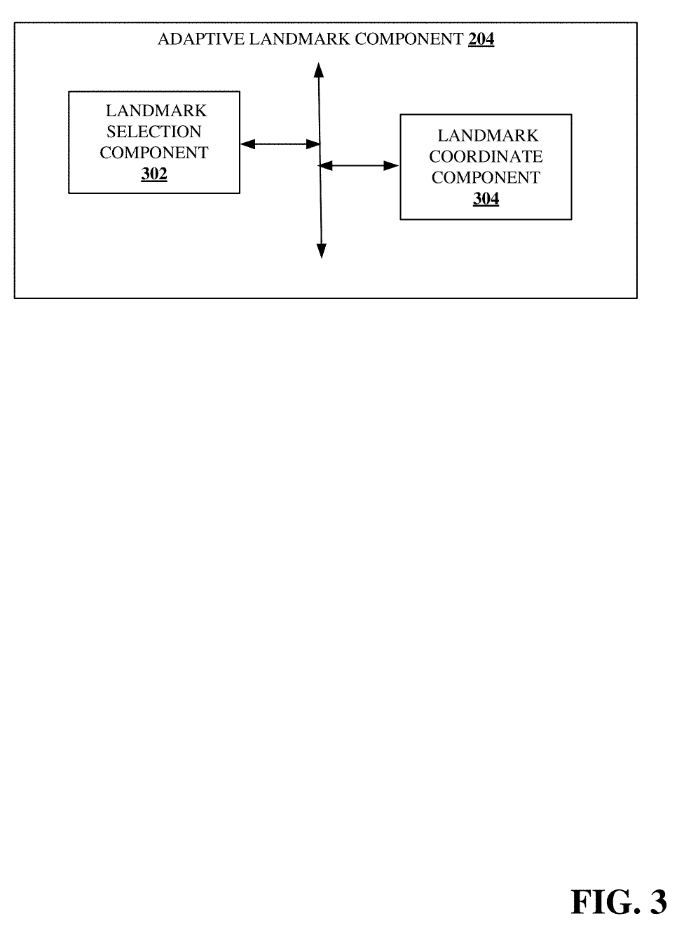

FIG. 3 illustrates another, non-limiting, example of a system component in accordance with one or more embodiments of the present invention. Adaptive landmark component 204 that can dynamically determine one or more landmarks to produce a set of landmarks that includes at least four non-planar landmarks, and determine respective coordinates for the landmarks in a coordinate space. As depicted, adaptive landmark component 204 can include a landmark selection component 302 and a landmark coordinate component 304.

Landmark selection component 302 that can access a captured image from the stream of captured images from camera 114 and use a landmark selection algorithm to determine a set of landmarks of the head and/or face from portions of the head and/or face that are visible in the captured image for use in head pose estimation and/or gaze estimation, where the set of landmarks comprises a defined quantity of non-planer landmarks. Non-limiting examples of landmark selection algorithms can include a deep learning algorithm, a Convolutional Neural Network (CNN) algorithm, Long short-term memory (LSTM) algorithm, Gated Recurrent Unit (GRU) algorithm, Attention Mechanism Deep Learning algorithm, Recurrent Neural Network (RNN) algorithm, a neural network algorithms, support vector machines (SVM), morphable model, an OpenFace Library model, a Google Facial Landmark Detector, or any other suitable landmark selection algorithm. In a non-limiting example, the defined quantity is at least four non-planer landmarks. In another non-limiting example, the defined quantity can be 5, 6, 7, or any other suitable quantity. For example, increasing the quantity of landmarks can allow for more accurate head pose estimation and/or gaze estimation by gaze determination component 104. It is to be appreciated that the defined quantity of non-planer landmarks can be defined, operator specified, and/or dynamically determined, for example, based on learning algorithms For example, the defined quantity can be dynamically selected by landmark selection component 302 based on a defined accuracy level inputted by a user. In another example, the defined quantity can be specified by a system administrator or user (e.g., operator).

As additional captured images from the stream of captured images from camera 114 are obtained, landmark selection component 302 can determine another set of landmarks of the head and/or face from portions of the head and/or face that are visible in an additional captured image for use in head pose estimation and/or gaze estimation. It is to be appreciated that all or some of the landmarks can be the same as landmarks in a set of landmarks associated with a previously captured image. For example, if all of the landmarks from a previously captured image are visible in the additional captured image, then landmark selection component 302 can employ (e.g., determine, identify, or select) the same set of landmarks, which can be in different locations of the additional captured image due to movement of the head. In another example, if some of the landmarks from the previously captured image are no longer visible in the additional captured image, landmark selection component 302 can determine one or more additional landmarks that are visible in the additional captured image to meet the defined quantity. This can occur, for example, due to movement of the head with respect to camera 114 such that a portion of the head comprising one or more landmarks in a previously captured image is no longer visible in the additional captured image.

In a further example, if the defined quantity has increased since the previously captured image, landmark selection component 302 can employ (e.g., determine, identify, or select) any previous landmarks that are still visible in the additional captured image, and determine one or more additional landmarks that are visible in the additional captured image to meet the increased defined quantity. In an additional example, if the defined quantity has decreased since the previously captured image, adaptive landmark component 204 can remove one or more landmarks from the set, and/or determine one or more additional landmarks that are visible in the additional captured image, to meet the decreased defined quantity.

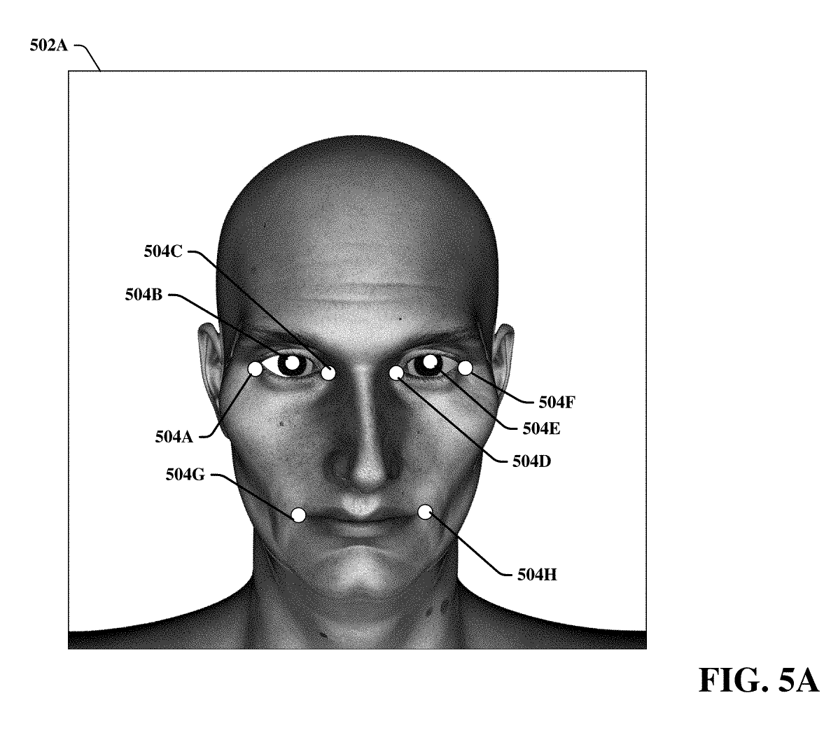

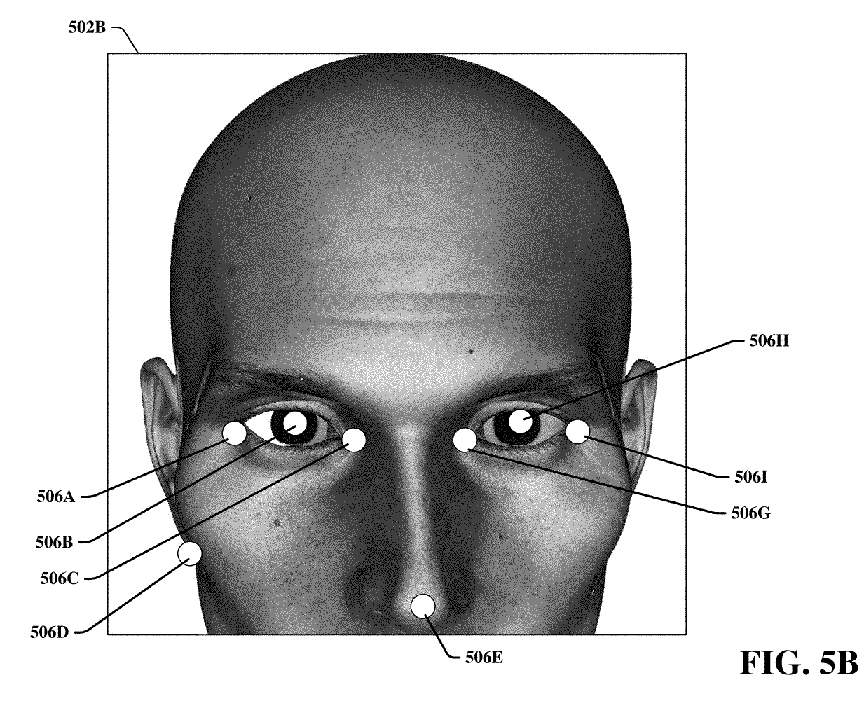

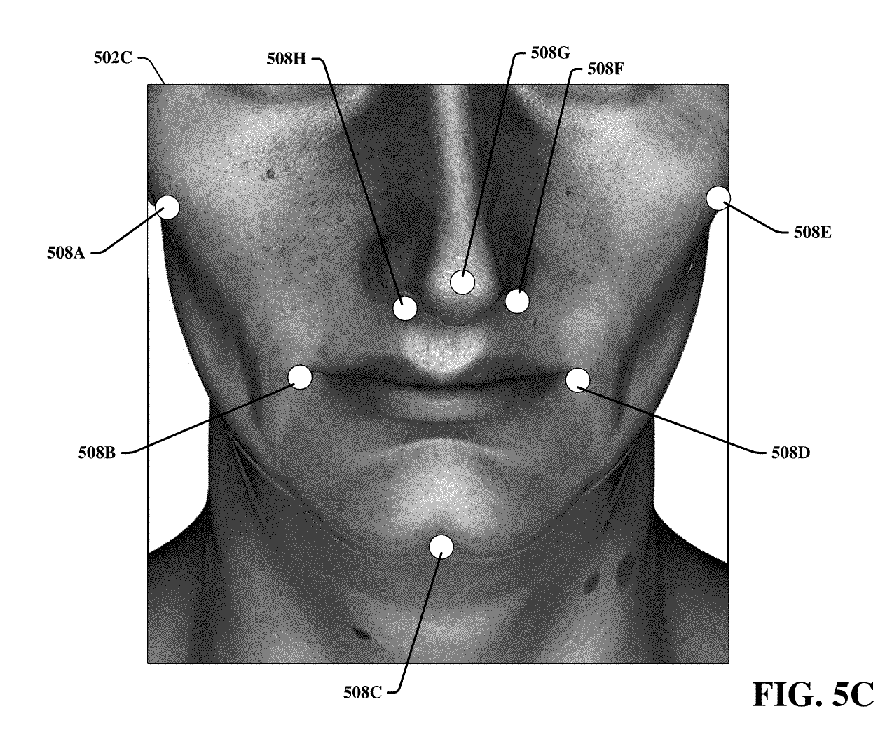

FIG. 5A illustrates an exemplary, non-limiting, image with landmarks identified in accordance with one or more embodiments of the present invention.

FIG. 5B illustrates another exemplary, non-limiting, image with landmarks identified in accordance with one or more embodiments of the present invention.

FIG. 5C illustrates yet another exemplary, non-limiting, image with landmarks identified in accordance with one or more embodiments of the present invention.

With particular reference now to FIGS. 5A-5C, a first image 502A (depicted in FIG. 5A) is captured. As depicted, captured image 502A can include an entire face. In some embodiments, a first set of landmarks is determined. In some embodiments, the landmarks meet a pre-defined quantity. For purposes of this example, a set of eight landmarks are depicted and are pre-defined: two corners 504A and 504C of the left eye, the pupil of the left eye 504B, two corners 504D and 504F of the right eye, the pupil of the right eye 504E, and the two corners 504G and 504H of the mouth

In response to obtaining a second captured image 502B (depicted in FIG. 5B) of an incomplete face e.g., that does not include the mouth, a second set of landmarks is determined. As depicted in FIG. 5B, the landmarks can include eight landmarks: two corners 506A and 506C of the left eye corresponding to 504A and 504C, the pupil of the left eye 506B corresponding to 504B, two corners 506G and 5061 of the right eye corresponding to 504D and 504F, the pupil of the right eye 506H corresponding to 504E, the left ear lobe 506D, and the tip of the nose 506E.

In response to obtaining a third captured image 502C (depicted in FIG. 5C) of the face that does not include the eyes, landmark selection component 302 can determine a third set of landmarks including eight landmarks: left ear lobe 508A corresponding to 506D, right ear lobe 508E, the tip of the nose 508G corresponding to 506E, the left nostril opening 508H, the right nostril opening 508F, the two corners of the mouth 508B and 508D corresponding to 504G and 504H, and the tip of the chin 508C.

Referring also now to FIG. 3, landmark selection component 302 can determine one or more of the above sets of landmarks and may continue to determine additional sets of landmarks as additional images are captured/obtained. In a further non-limiting example, landmark selection component 302 can determine sets of landmarks for each captured image in a stream of captured images. In another non-limiting example, landmark selection component 302 can determine sets of landmarks for randomly or periodically (e.g., fixed or dynamic interval) selected captured images in a stream of captured images.

Landmark coordinate component 304 can determine respective 3D coordinates in a coordinate space for landmarks in a set of landmarks for a captured image using a coordinate algorithm and the 3D head model. For example, referring back to FIG. 5A, landmark coordinate component 304 can determine a set of 3D coordinates in a coordinate space for the set of landmarks 504A, 504B, 504C, 504D, 504E, 504F, 504G, and 504H.

Referring back to FIG. 2, gaze determination component 104 can also include head-eye pose component 206 that can determine head pose and/or eye pose for a captured image based upon a set of coordinates for a set of landmarks determined for the captured image. Some embodiments of head-eye pose component 206 can use a head pose algorithm and/or an eye pose algorithm. Non-limiting examples of head pose algorithms can include a deep learning algorithm, a Convolutional Neural Network (CNN) algorithm, Long short-term memory (LSTM) algorithm, Gated Recurrent Unit (GRU) algorithm, Attention Mechanism Deep Learning algorithm, Recurrent Neural Network (RNN) algorithm, a neural network algorithms, support vector machines (SVM), morphable model, an OpenFace Library model, or any other suitable head pose algorithm. For example, referring back to FIG. 5B, head-eye pose component 206 can determine a head pose vector based on the set of 3D coordinates in the coordinate space for the set of landmarks 506A, 506B, 506C, 506D, 506E, 506F, 506G, and 506H.

Non-limiting examples of eye pose algorithms can include an eye center localization and detection using radial mapping model, a deep learning algorithm, a Convolutional Neural Network (CNN) algorithm, Long short-term memory (LSTM) algorithm, Gated Recurrent Unit (GRU) algorithm, Attention Mechanism Deep Learning algorithm, Recurrent Neural Network (RNN) algorithm, a neural network algorithms, support vector machines (SVM), morphable model, an OpenFace Library model, or any other suitable eye pose algorithm. In a non-limiting example, head-eye pose component 206 can create respective gaze vectors for both eyes, if both eyes are available. In another non-limiting example, head-eye pose component 206 can create a gaze vector for one eye, if only one eye is visible in a captured image. For example, referring back to FIG. 5B, head-eye pose component 206 can determine an eye pose vector based on the set of 3D coordinates in the coordinate space for the set of landmarks 506A, 506B, 506C, 506D, 506E, 506F, 506G, and 506H.

Referring again to FIG. 2, gaze determination component 104 can also include gaze vector component 208 that can determine a gaze vector for a captured image based upon a head pose vector and/or an eye pose vector determined for a captured image using a gaze estimation algorithm. A few non-limiting examples of gaze estimation algorithms can include a geometrical model, a deep learning algorithm, a Convolutional Neural Network (CNN) algorithm, Long short-term memory (LSTM) algorithm, Gated Recurrent Unit (GRU) algorithm, Attention Mechanism Deep Learning algorithm, Recurrent Neural Network (RNN) algorithm, a neural network algorithms, support vector machines (SVM), morphable model, an OpenFace Library model, or any other suitable head pose algorithm. For example, referring back to FIG. 5C, gaze vector component 208 can determine a gaze vector based on the head pose and/or eye pose determined from a set of 3D coordinates in the coordinate space for the set of landmarks 508A, 508B, 508C, 508D, 508E, 508F, 508G, and 508H.

Gaze determination component 104 can also include output component 210 that can present a display with information including the gaze vector and/or information associated with the gaze vector. Furthermore, output component 210 can perform an action based on the gaze vector. For example, output component 210 can cause computing device 102 to display a pop-up window at a location on a display at which the gaze vector intersects. In another example, output component 210 can cause computing device 102 to trigger a sound that draws the attention of user associated with gaze vector in response to determining the gaze vector does not intersect with a portion of a display to which the user's attention should be directed.

In another example, output component 210 can send a transmission including the gaze vector to a device that initiates the device to perform an action based on the gaze vector. For example, output component 210 can send a transmission including the gaze vector to a robotic device that initiates the robotic device to assist a user associated with gaze vector in performing a task to which the user's gaze is directed.

Although FIGS. 1, 2, and 3 depict separate components in computing device 102, it is to be appreciated that two or more components can be implemented in a common component. Further, it is to be appreciated that the design of the computing device 102 can include other component selections, component placements, etc., to facilitate automatically generating a 3D head and/or face model that is specific to a particular head, and dynamically determining one or more additional landmarks to produce a set of landmarks that includes at least four non-planar landmarks, in response to receiving a captured image that excludes a portion of a head or face that included one or more landmarks previously employed for gaze estimation/tracking from a previously captured image of the head or face in accordance with one or more embodiments of the present invention. Moreover, the aforementioned systems and/or devices have been described with respect to interaction between several components. It should be appreciated that such systems and components can include those components or sub-components specified therein, some of the specified components or sub-components, and/or additional components. Sub-components could also be implemented as components communicatively coupled to other components rather than included within parent components. Further yet, one or more components and/or sub-components can be combined into a single component providing aggregate functionality. The components can also interact with one or more other components not specifically described herein for the sake of brevity, but known by those of skill in the art.

Further, some of the functions can be performed by specialized computers for carrying out defined tasks related to automatically generating recommended query terms that are specialized to a topic of desired information based on a query associated with a user. The subject computer processing systems, methods apparatuses and/or computer program products can be employed to solve new problems that arise through advancements in technology, computer networks, the Internet and the like. The subject computer processing systems, methods apparatuses and/or computer program products can provide technical improvements to systems automatically generating a 3D head and/or face model that is specific to a particular head, and dynamically determining one or more additional landmarks to produce a set of landmarks that includes at least four non-planar landmarks, in response to receiving a captured image that excludes a portion of a head or face that included one or more landmarks previously employed for gaze estimation/tracking from a previously captured image of the head or face in a live environment by improving processing efficiency among processing components in these systems, reducing delay in processing performed by the processing components, and/or improving the accuracy in which the processing systems automatically generate a 3D head and/or face model that is specific to a particular head, and dynamically determine one or more additional landmarks to produce a set of landmarks that includes at least four non-planar landmarks, in response to receiving a captured image that excludes a portion of a head or face that included one or more landmarks previously employed for gaze estimation/tracking from a previously captured image of the head or face.

Some embodiments of the present invention herein can employ artificial intelligence (AI) to facilitate automating one or more features of the present invention. The components can employ various AI-based schemes for carrying out various embodiments/examples disclosed herein. In order to provide for or aid in the numerous determinations (e.g., determine, ascertain, infer, calculate, predict, prognose, estimate, derive, forecast, detect, compute) of the present invention, components of the present invention can examine the entirety or a subset of the data to which it is granted access and can provide for reasoning about or determine states of the system, environment, etc. from a set of observations as captured via events and/or data. Determinations can be employed to identify a specific context or action, or can generate a probability distribution over states, for example. The determinations can be probabilistic—that is, the computation of a probability distribution over states of interest based on a consideration of data and events. Determinations can also refer to techniques employed for composing higher-level events from a set of events and/or data.

Such determinations can result in the construction of new events or actions from a set of observed events and/or stored event data, whether or not the events are correlated in close temporal proximity, and whether the events and data come from one or several event and data sources. Components disclosed herein can employ various classification (explicitly trained (e.g., via training data) as well as implicitly trained (e.g., via observing behavior, preferences, historical information, receiving extrinsic information, etc.)) schemes and/or systems (e.g., support vector machines, neural networks, expert systems, Bayesian belief networks, fuzzy logic, data fusion engines, etc.) in connection with performing automatic and/or determined action in connection with the claimed subject matter. Thus, classification schemes and/or systems can be used to automatically learn and perform a number of functions, actions, and/or determination.

A classifier can map an input attribute vector, z=(z1, z2, z3, z4, zn), to a confidence that the input belongs to a class, as by f(z)=confidence(class). Such classification can employ a probabilistic and/or statistical-based analysis (e.g., factoring into the analysis utilities and costs) to determinate an action to be automatically performed. A support vector machine (SVM) can be an example of a classifier that can be employed. The SVM operates by finding a hyper-surface in the space of possible inputs, where the hyper-surface attempts to split the triggering criteria from the non-triggering events. Intuitively, this makes the classification correct for testing data that is near, but not identical to training data. Other directed and undirected model classification approaches include, e.g., naïve Bayes, Bayesian networks, decision trees, neural networks, fuzzy logic models, and/or probabilistic classification models providing different patterns of independence can be employed. Classification as used herein also is inclusive of statistical regression that is utilized to develop models of priority.

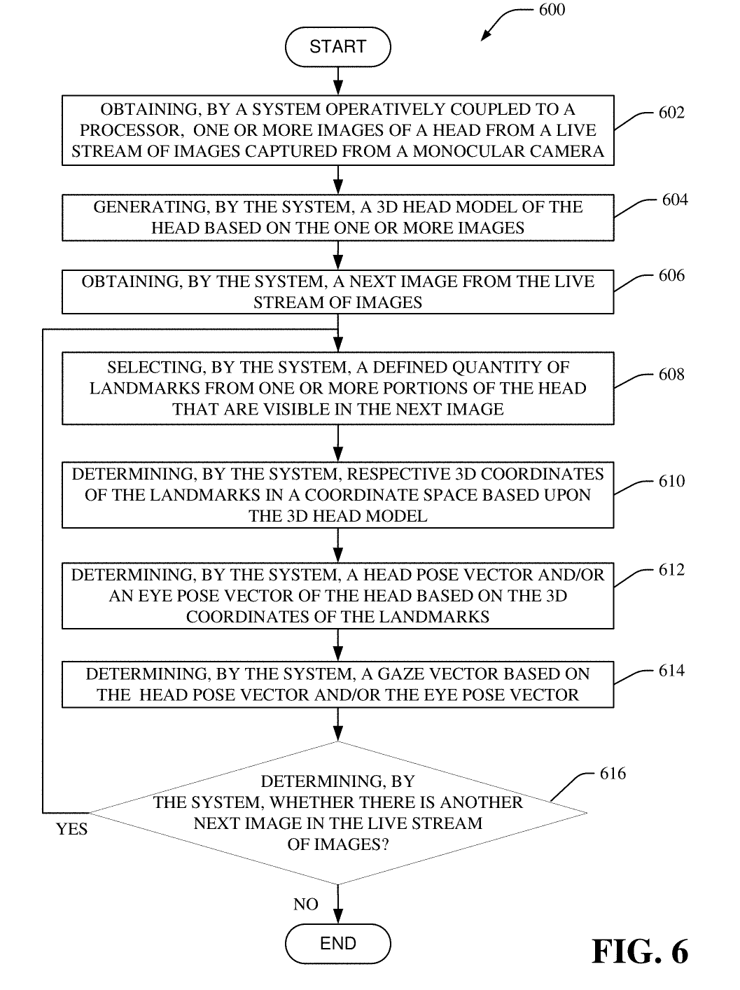

FIG. 6 illustrates an example, non-limiting computer-implemented method in accordance with one or more embodiments of the present invention. Method 600 can facilitate automatically generating a 3D head and/or face model that is specific to a particular head, and dynamically determining one or more additional landmarks to produce a set of landmarks that includes at least four non-planar landmarks, in response to receiving a captured image that excludes a portion of a head or face that included one or more landmarks previously employed for gaze estimation/tracking from a previously captured image of the head or face in accordance with one or more embodiments of the present invention. Repetitive description of like elements employed in other embodiments of the present invention is omitted for sake of brevity.

At 602, method 600 can comprise obtaining, by a system operatively coupled to a processor, one or more images of a head from a live stream of images captured from a monocular camera (e.g., via a head modeling component 202, a gaze determination component 104, and/or a computing device 102). At 604, method 600 can comprise generating, by the system, a 3D head model of the head based on the one or more images (e.g., via a head modeling component 202, a gaze determination component 104, and/or a computing device 102). At 606, method 600 can comprise obtaining, by the system, a next image from the live stream of images (e.g., via an adaptive landmark component 204, a gaze determination component 104, and/or a computing device 102). At 608, method 600 can comprise selecting, by the system, a defined quantity of landmarks from one or more portions of the head that are visible in the next image (e.g., via a landmark selection component 302, an adaptive landmark component 204, a gaze determination component 104, and/or a computing device 102). At 610, method 600 can comprise determining, by the system, respective 3D coordinates of the landmarks in a coordinate space based upon the 3d head model (e.g., via a landmark coordinate component 304, an adaptive landmark component 204, a gaze determination component 104, and/or a computing device 102). At 612, method 600 can comprise determining, by the system, a head pose vector and/or an eye pose vector of the head based on the 3d coordinates of the landmarks (e.g., via a head-eye pose component 206, a gaze determination component 104, and/or a computing device 102). At 614, method 600 can comprise determining, by the system, a gaze vector based on the head pose vector and/or the eye pose vector (e.g., via a gaze vector component 208, a gaze determination component 104, and/or a computing device 102). At 616, a determination is made whether there is another next image in the live stream of images (e.g., via an adaptive landmark component 204, a gaze determination component 104, and/or a computing device 102). If the determination is “NO,” meaning that there is not another next image in the live stream of images, the method can end. If the determination is “YES,” meaning that there is another next image in the live stream of images, the method can proceed to 608 using the other next image in the live stream of images as the next image at 608.

FIG. 6 illustrates an example, non-limiting computer-implemented method in accordance with one or more embodiments of the present invention. Method 700 can facilitate automatically dynamically determining one or more additional landmarks to produce a set of landmarks that includes at least four non-planar landmarks, in response to receiving a captured image that excludes a portion of a head or face that included one or more landmarks previously employed for gaze estimation/tracking from a previously captured image of the head or face in accordance with one or more embodiments of the present invention. In a non-limiting example, method 700 can be employed at step 608 of method 600. Repetitive description of like elements employed in other embodiments of the present invention is omitted for sake of brevity.

At 702, a determination is made whether any landmarks of a head from a previous image of the head are visible in a current image of the head (e.g., via a landmark selection component 302, an adaptive landmark component 204, a gaze determination component 104, and/or a computing device 102). If the determination is “NO,” meaning that there are no landmarks of the head from the previous image of the head that are visible in the current image of the head, the method can proceed to 704. If the determination is “YES,” meaning that there is one or more landmarks of the head from the previous image of the head that are visible in the current image of the head, the method can proceed to 708. At 704, method 700 can comprise determining, by the system, a defined quantity of additional landmarks of the head from the current image that were not landmarks of the head from the previous image (e.g., via a landmark selection component 302, an adaptive landmark component 204, a gaze determination component 104, and/or a computing device 102). At 706, method 700 can comprise adding, by the system, the defined quantity of additional landmarks to a set of landmarks for the current image (e.g., via a landmark selection component 302, an adaptive landmark component 204, a gaze determination component 104, and/or a computing device 102).

At 708, method 700 can comprise adding, by the system, landmarks of the head from the current image that were landmarks of the head from the previous image to a set of landmarks for the current image (e.g., via a landmark selection component 302, an adaptive landmark component 204, a gaze determination component 104, and/or a computing device 102). At 710, method 700 can comprise, if the set of landmarks does not have a defined quantity of landmarks, determining, by the system one or more additional landmarks from the current image that were not landmarks of the head from the previous image to meet the defined quantity, and adding the one or more additional landmarks to the set of landmarks (e.g., via a landmark selection component 302, an adaptive landmark component 204, a gaze determination component 104, and/or a computing device 102).

One or more processes in accordance with the present invention can be performed by one or more computers (e.g., computing device 102) specifically adapted (or specialized) for carrying out defined tasks related to automatically determining a gaze vector using dynamically determined landmarks.

For simplicity of explanation, the computer-implemented methodologies in accordance with the present invention are depicted and described as a series of acts. It is to be understood and appreciated that the subject innovation is not limited by the acts illustrated and/or by the order of acts, for example acts can occur in various orders and/or concurrently, and with other acts not presented and described herein. Furthermore, not all illustrated acts can be required to implement the computer-implemented methodologies in accordance with the disclosed subject matter. In addition, those skilled in the art will understand and appreciate that the computer-implemented methodologies could alternatively be represented as a series of interrelated states via a state diagram or events. Additionally, it should be further appreciated that the computer-implemented methodologies disclosed hereinafter and throughout this specification are capable of being stored on an article of manufacture to facilitate transporting and transferring such computer-implemented methodologies to computers. The term article of manufacture, as used herein, is intended to encompass a computer program accessible from any computer-readable device or storage media.

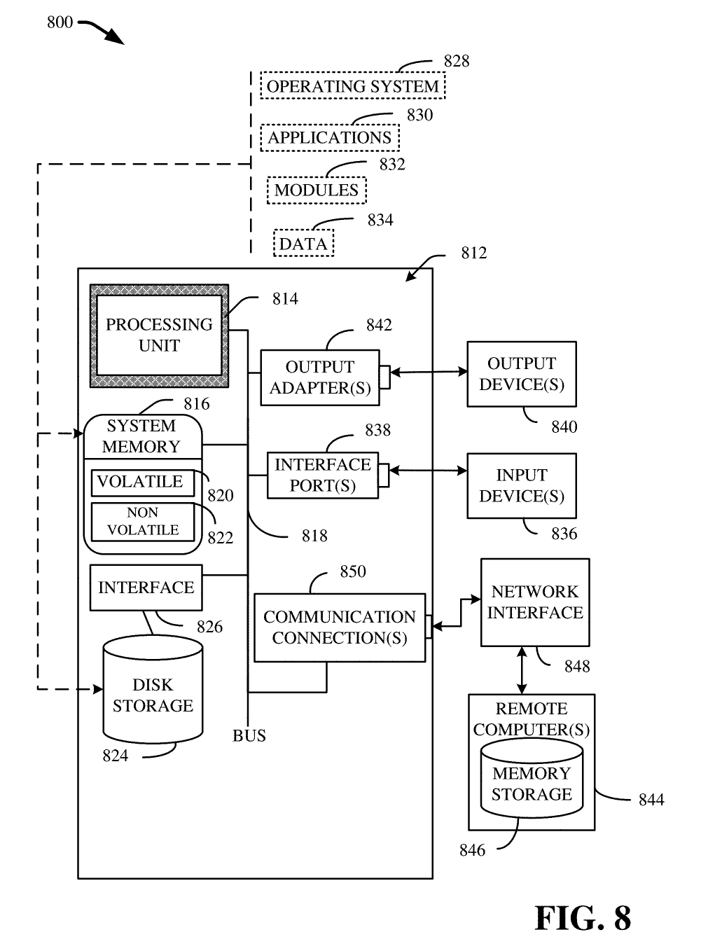

In order to better provide context for various aspects of the invention, FIG. 8 as well as the following discussion are intended to provide a general description of a suitable environment in which various aspects of the disclosed subject matter can be implemented. FIG. 8 illustrates an example, non-limiting operating environment in accordance with one or more embodiments of the present invention. Repetitive description of like elements employed in other embodiments of the present invention is omitted for sake of brevity.

With reference to FIG. 8, operating environment 800 can include a computer 812. The computer 812 (similar to the example computing device 102 of FIG. 1) can also include a processing unit 814, a system memory 816, and a system bus 818. The system bus 818 operably couples system components including, but not limited to, the system memory 816 to the processing unit 814. The processing unit 814 can be any of various available processors. Dual microprocessors and other multiprocessor architectures also can be employed as the processing unit 814. The system bus 818 can be any of several types of bus structure(s) including the memory bus or memory controller, a peripheral bus or external bus, and/or a local bus using any variety of available bus architectures including, but not limited to, Industrial Standard Architecture (ISA), Micro-Channel Architecture (MSA), Extended ISA (EISA), Intelligent Drive Electronics (IDE), VESA Local Bus (VLB), Peripheral Component Interconnect (PCI), Card Bus, Universal Serial Bus (USB), Advanced Graphics Port (AGP), Firewire (IEEE 1394), and Small Computer Systems Interface (SCSI). The system memory 816 can also include volatile memory 820 and nonvolatile memory 822. By way of illustration, and not limitation, nonvolatile memory 822 can include read only memory (ROM), programmable ROM (PROM), electrically programmable ROM (EPROM), electrically erasable programmable ROM (EEPROM), flash memory, or nonvolatile random access memory (RAM) (e.g., ferroelectric RAM (FeRAM). The basic input/output system (BIOS), containing the basic routines to transfer information between elements within the computer 812, such as during start-up, is stored in nonvolatile memory 822.

Volatile memory 820 can also include random access memory (RAM), which acts as external cache memory. By way of illustration and not limitation, RAM is available in many forms such as static RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), direct Rambus RAM (DRRAM), direct Rambus dynamic RAM (DRDRAM), and Rambus dynamic RAM.

Computer 812 can also include removable/non-removable, volatile/non-volatile computer storage media. FIG. 8 illustrates, for example, a disk storage 824. Disk storage 824 can also include, but is not limited to, devices like a magnetic disk drive, floppy disk drive, tape drive, Jaz drive, Zip drive, LS-100 drive, flash memory card, or memory stick. The disk storage 824 also can include storage media separately or in combination with other storage media including, but not limited to, an optical disk drive such as a compact disk ROM device (CD-ROM), CD recordable drive (CD-R Drive), CD rewritable drive (CD-RW Drive) or a digital versatile disk ROM drive (DVD-ROM). To facilitate connection of the disk storage 824 to the system bus 818, a removable or non-removable interface is typically used, such as interface 826.

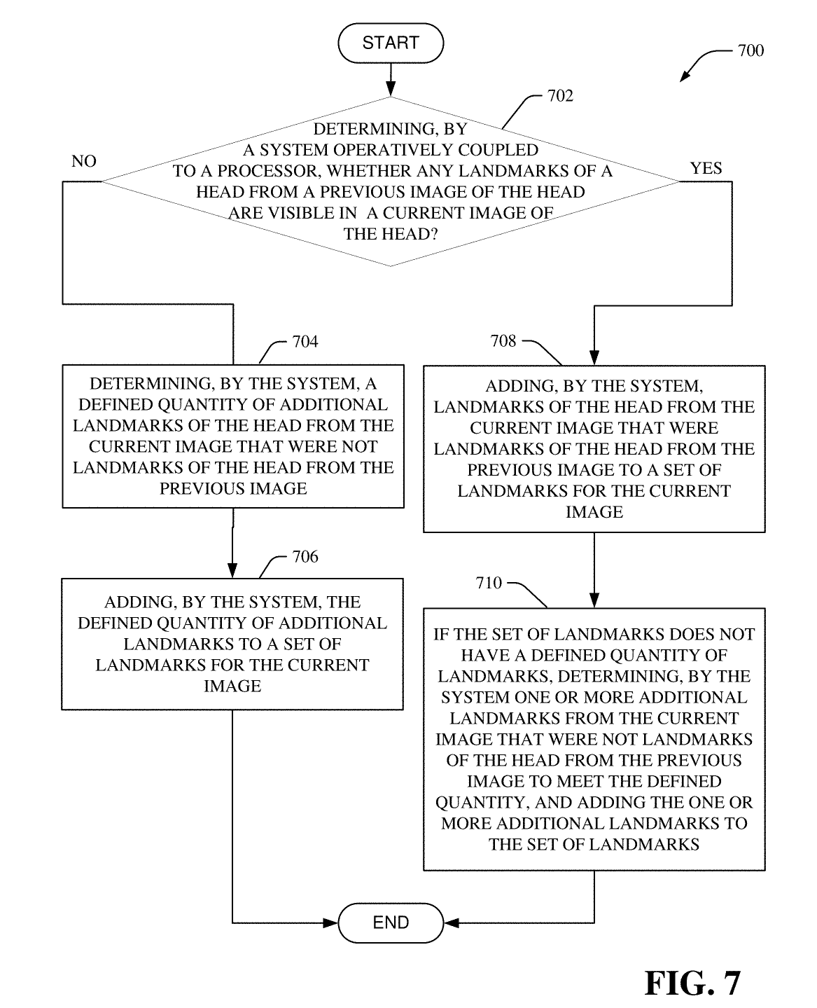

Operating environment 800 can also include software that acts as an intermediary between users and the basic computer resources described in operating environment 800. Such software can also include, for example, an operating system 828. Operating system 828, which can be stored on disk storage 824, acts to control and allocate resources of the computer 812. Applications 830 can take advantage of the management of resources by operating system 828 through program modules 832 and program data 834, e.g., stored either in system memory 816 or on disk storage 824. In some embodiments, applications 830 include one or more aspects gaze determination component 104 (FIG. 1) and/or embody one or more of the processes described with reference to FIG. 6 and/or FIG. 7.

It is to be appreciated that this invention can be implemented with various operating systems or combinations of operating systems. Referring again to FIG. 8, commands or information can be input to the computer 812 through input device(s) 836. Examples of input devices 836 include, but are not limited to, a pointing device such as a mouse, trackball, stylus, touch pad, keyboard, microphone, joystick, game pad, satellite dish, scanner, TV tuner card, digital camera, digital video camera, web camera, and the like. The input devices (and possibly other devices) can connect to the processing unit 814 through the system bus 818 via interface port(s) 838. Interface port(s) 838 include, for example, a serial port, a parallel port, a game port, and a universal serial bus (USB). Output device(s) 840 can use some of the same type of ports as input device(s) 836. Thus, for example, a USB port can be used to provide input to computer 812, and to output information from computer 812 to an output device 840. Output adapter 842 is provided to illustrate that there are some output devices 840 like monitors, speakers, and printers, among other output devices 840, which require special adapters. The output adapters 842 include, by way of illustration and not limitation, video and sound cards that provide a means of connection between the output device 840 and the system bus 818. It should be noted that other devices and/or systems of devices provide both input and output capabilities such as remote computer(s) 844.

Computer 812 can operate in a networked environment using logical connections to one or more remote computers, such as remote computer(s) 844. The remote computer(s) 844 can be a computer, a server, a router, a network PC, a workstation, a microprocessor based appliance, a peer device or other common network node and the like, and typically can also include many or all of the elements described relative to computer 812. For purposes of brevity, only a memory storage device 846 is illustrated with remote computer(s) 844. Remote computer(s) 844 is logically connected to computer 812 through a network interface 848 and then physically connected via communication connection 850. Network interface 848 encompasses wire and/or wireless communication networks such as local-area networks (LAN), wide-area networks (WAN), cellular networks, etc. LAN technologies include Fiber Distributed Data Interface (FDDI), Copper Distributed Data Interface (CDDI), Ethernet, Token Ring and the like. WAN technologies include, but are not limited to, point-to-point links, circuit switching networks like Integrated Services Digital Networks (ISDN) and variations thereon, packet switching networks, and Digital Subscriber Lines (DSL). Communication connection(s) 850 refers to the hardware/software employed to connect the network interface 848 to the system bus 818. While communication connection 850 is shown for illustrative clarity inside computer 812, it can also be external to computer 812. The hardware/software for connection to the network interface 848 can also include, for exemplary purposes only, internal and external technologies such as, modems including regular telephone grade modems, cable modems and DSL modems, ISDN adapters, and Ethernet cards.

In an embodiment, for example, computer 812 can perform operations comprising: determining a second set of landmarks of a head from a second image of the head of a stream of images of the head, wherein the second set of landmarks comprises a defined quantity of landmarks, wherein the defined quantity is at least four non-planar landmarks, wherein the second set of landmarks comprises at least one landmark that was not in a first set of landmarks of the head used for gaze estimation associated with a first image of the head that is prior to the second image in the stream of images; and determining a gaze vector for the head based on the second set of landmarks.

It is to be appreciated that operations of embodiments disclosed herein can be distributed across multiple (local and/or remote) systems.

Embodiments of the present invention may be a system, a method, an apparatus and/or a computer program product at any possible technical detail level of integration. The computer program product can include a computer readable storage medium (or media) having computer readable program instructions thereon for causing a processor to carry out aspects of the present invention. The computer readable storage medium can be a tangible device that can retain and store instructions for use by an instruction execution device. The computer readable storage medium can be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium can also include the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network can comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device. Computer readable program instructions for carrying out operations of various aspects of the present invention can be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions can execute entirely on the user's computer, partly on the user's computer, as a stand-alone software package, partly on the user's computer and partly on a remote computer or entirely on the remote computer or server. In the latter scenario, the remote computer can be connected to the user's computer through any type of network, including a local area network (LAN) or a wide area network (WAN), or the connection can be made to an external computer (for example, through the Internet using an Internet Service Provider). In some embodiments, electronic circuitry including, for example, programmable logic circuitry, field-programmable gate arrays (FPGA), or programmable logic arrays (PLA) can execute the computer readable program instructions by utilizing state information of the computer readable program instructions to customize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions. These computer readable program instructions can be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions can also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks. The computer readable program instructions can also be loaded onto a computer, other programmable data processing apparatus, or other device to cause a series of operational acts to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams can represent a module, segment, or portion of instructions, which comprises one or more executable instructions for implementing the specified logical function(s). In some alternative implementations, the functions noted in the blocks can occur out of the order noted in the Figures. For example, two blocks shown in succession can, in fact, be executed substantially concurrently, or the blocks can sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

While the subject matter has been described above in the general context of computer-executable instructions of a computer program product that runs on a computer and/or computers, those skilled in the art will recognize that this invention also can or can be implemented in combination with other program modules. Generally, program modules include routines, programs, components, data structures, etc. that perform particular tasks and/or implement particular abstract data types. Moreover, those skilled in the art will appreciate that the inventive computer-implemented methods can be practiced with other computer system configurations, including single-processor or multiprocessor computer systems, mini-computing devices, mainframe computers, as well as computers, hand-held computing devices (e.g., PDA, phone), microprocessor-based or programmable consumer or industrial electronics, and the like. The illustrated aspects can also be practiced in distributed computing environments where tasks are performed by remote processing devices that are linked through a communications network. However, some, if not all aspects of this invention can be practiced on stand-alone computers. In a distributed computing environment, program modules can be located in both local and remote memory storage devices.

As used in this application, the terms “component,” “system,” “platform,” “interface,” and the like, can refer to and/or can include a computer-related entity or an entity related to an operational machine with one or more specific functionalities. The entities disclosed herein can be either hardware, a combination of hardware and software, software, or software in execution. For example, a component can be, but is not limited to being, a process running on a processor, a processor, an object, an executable, a thread of execution, a program, and/or a computer. By way of illustration, both an application running on a server and the server can be a component. One or more components can reside within a process and/or thread of execution and a component can be localized on one computer and/or distributed between two or more computers. In another example, respective components can execute from various computer readable media having various data structures stored thereon. The components can communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software or firmware application executed by a processor. In such a case, the processor can be internal or external to the apparatus and can execute at least a part of the software or firmware application. As yet another example, a component can be an apparatus that provides specific functionality through electronic components without mechanical parts, wherein the electronic components can include a processor or other means to execute software or firmware that confers at least in part the functionality of the electronic components. In an aspect, a component can emulate an electronic component via a virtual machine, e.g., within a server computing system.

In addition, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. Moreover, articles “a” and “an” as used in the subject specification and annexed drawings should generally be construed to mean “one or more” unless specified otherwise or clear from context to be directed to a singular form. As used herein, the terms “example” and/or “exemplary” are utilized to mean serving as an example, instance, or illustration. For the avoidance of doubt, the subject matter of the present invention is not limited by such examples. In addition, any aspect or design described herein as an “example” and/or “exemplary” is not necessarily to be construed as preferred or advantageous over other aspects or designs, nor is it meant to preclude equivalent exemplary structures and techniques known to those of ordinary skill in the art.

As it is employed in the subject specification, the term “processor” can refer to substantially any computing processing unit or device comprising, but not limited to, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components, or any combination thereof. Further, processors can exploit nano-scale architectures such as, but not limited to, molecular and quantum-dot based transistors, switches and gates, in order to optimize space usage or enhance performance of user equipment. A processor can also be implemented as a combination of computing processing units. In this invention, terms such as “store,” “storage,” “data store,” data storage,” “database,” and substantially any other information storage component relevant to operation and functionality of a component are utilized to refer to “memory components,” entities embodied in a “memory,” or components comprising a memory. It is to be appreciated that memory and/or memory components of the present invention can be either volatile memory or nonvolatile memory, or can include both volatile and nonvolatile memory. By way of illustration, and not limitation, nonvolatile memory can include read only memory (ROM), programmable ROM (PROM), electrically programmable ROM (EPROM), electrically erasable ROM (EEPROM), flash memory, or nonvolatile random access memory (RAM) (e.g., ferroelectric RAM (FeRAM). Volatile memory can include RAM, which can act as external cache memory, for example. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), direct Rambus RAM (DRRAM), direct Rambus dynamic RAM (DRDRAM), and Rambus dynamic RAM (RDRAM). Additionally, the disclosed memory components of systems or computer-implemented methods herein are intended to include, without being limited to including, these and any other suitable types of memory.

What has been described above include mere examples of systems, computer program products, and computer-implemented methods. It is, of course, not possible to describe every conceivable combination of components, products and/or computer-implemented methods for purposes of describing this invention, but one of ordinary skill in the art can recognize that many further combinations and permutations of this invention are possible. Furthermore, to the extent that the terms “includes,” “has,” “possesses,” and the like are used in the detailed description, claims, appendices and drawings such terms are intended to be inclusive in a manner similar to the term “comprising” as “comprising” is interpreted when employed as a transitional word in a claim. The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method, comprising:
determining, by a system operatively coupled to a processor, a second set of landmarks of a head from a second image of the head of a stream of images of the head, wherein the second set of landmarks comprises a defined quantity of landmarks, wherein the defined quantity is at least four non-planar landmarks, wherein the second set of landmarks comprises at least one landmark that was not in a first set of landmarks of the head used for gaze estimation associated with a first image of the head that is prior to the second image in the stream of images; and
determining, by the system, a gaze vector for the head based on the second set of landmarks.

2. The computer-implemented method of claim 1, wherein the determining the second set of landmarks comprises, based on determining that at least one landmark of the first set of landmarks is also visible in the second image:
adding the at least one landmark of the first set of landmarks that is also visible in the second image to the second set of landmarks; and
based on determining that the second set of landmarks does not have the defined quantity of landmarks, determine one or more additional landmarks from the second image that were not landmarks of the first set of landmarks to meet the defined quantity, and add the one or more additional landmarks to the second set of landmarks.

3. The computer-implemented method of claim 1, wherein the determining the second set of landmarks comprises, based on determining that no landmarks of first set of landmarks are also visible in the second image:
determining the defined quantity of additional landmarks of the head from the second image that were not landmarks of the first set of landmarks to compensate for movement of portions of the head out of a visual field of the camera; and
adding the defined quantity of additional landmarks to the second set of landmarks.

4. The computer-implemented method of claim 1, further comprising generating, by the system, a three dimensional head model of the head based on one or more images from the stream of images.

5. The computer-implemented method of claim 4, further comprising generating, by the system, a set of three dimensional coordinates in a coordinate space of the second set of landmarks based on the three dimensional head model.

6. The computer-implemented method of claim 5, further comprising determining, by the system, at least one of a head pose vector of the head or an eye pose vector of the head based on the set of three dimensional coordinates.

7. The computer-implemented method of claim 6, further comprising determining, by the system, a gaze vector of the head based on the at least one of the head pose vector or the eye pose vector.
